(19) United States
(12) Patent Application Publication
(10) Pub. No.: US 2017/0334096 A1
(43) Pub. Date: Nov. 23, 2017

(54) MULTI-PIECE REMOVABLE TOOLING INSERT

(71) Applicant: Quatro Composites, Orange City, IA (US)

(72) Inventors: Robin L. Westberg, Ramona, CA (US); Jijoe K. Joseph, San Diego, CA (US)

(21) Appl. No.: 15/159,927

(22) Filed: May 20, 2016

(51) Int. Cl. B29C 33/48; B29C 43/22; B29C 43/42; B29C 43/50

(52) U.S. Cl. CPC B29C 33/48; B29C 43/50; B29C 43/22; B29C 43/42; B29C 2043/5007

(57) ABSTRACT

An improved device, system, and method to produce a molded component with an undercut includes an insert comprised of a plurality of separate pieces individually removable from the molded component. The pieces are arranged and functionally interlocked in an assembled configuration. Removal of a post member or piece from the insert creates a cavity within the same. Thereafter, one or more of the pieces is slidable, movable, or collapsible into the cavity and subsequently removed from the molded component. The remaining pieces are movable, often sequentially and iteratively, into the cavity and subsequently removed. Each of the pieces can have a different geometry. A plurality of the inserts can arranged into an array and connected to a bottom tool structure. The array of inserts can be configured to produce a molded component have a plurality of cells arranged in a matrix, such as a airflow diverter duct.

### FIELD OF THE DISCLOSURE

The present disclosure relates generally to a molding tool. More particularly, but not exclusively, the present disclosure relates to an improved device, system, and method capable of producing a molded component with an undercut.

### BACKGROUND OF THE DISCLOSURE

Whether it be for structural, functional, and/or aesthetic purposes, molded articles often require undercuts. An undercut is any indentation or protrusion in the shape of a molded article that prevents simple ejection of the component from a straight-pull mold. Undercuts are generally divided into two categories: external undercuts extending outwardly from an exterior of the article, and interior undercuts extending inwardly within an interior of the article. An exemplary external undercut is illustrated in FIG. 1C. Because undercuts prevent the simple ejection of the article, molds and/or molding operations capable of producing articles with undercuts are substantially more complex and associated with numerous shortcomings. The development of improved devices, systems, and/or methods for producing molded articles with undercuts is a subject of much study and innovation.

The exemplary methods by which undercuts are achieved typically impart movement of a component of the mold associated with the undercut in a direction transverse to the direction of the mold opening. For example, a side-action or side-pull mold includes an additional component that moves separately from the mold and withdraws (sideways) during mold opening to allow the molded article to be ejected (vertically). A simple side-action mold can include a pin that creates a hole within the component and moves transverse the direction of the opening of the mold. The extra component having independent movement increases the complexity of the mold as well as the molding machine.

Another exemplary method includes a slide mechanism comprising a portion of the molding surface that, during mold opening, moves angularly to provide clearance for the undercut to pass the molding surface. For example, U.S. Pat. No. 4,854,849 to Sudo discloses a mold having two inclined slide cores that move in both a direction parallel to the ejecting direction, and in a direction perpendicular to the same so as to permit the undercut of the molded article to clear the slide core. Another similar process is disclosed in U.S. Pat. No. 6,039,558 to Park et al. The use of slide mechanisms undesirably requires a considerable number of moving components and occupies considerable space within the mold. Further, should the design of the undercut change, the entire mold and/or molding operation must be redesigned or replaced. Still further, the increased complexity of the moving components provide for little error in the molding operation, increasing the likelihood of suboptimal molded articles or temporary failure of the molding operation. Therefore, a need exists in the art to provide an improved device, system and method that requires fewer moving components to improve consistency and reliability of molding operations.

Still another exemplary method for producing molded articles with undercuts uses collapsible cores. Prior to the advent of collapsible cores, molded components having threads were either “jumped” or unscrewed from the mold. If the material comprising the undercut is flexible enough, the mold can jump the threads of the article over counterposing threads of the mold. Another process utilizing elastically deformable material to produce undercuts is disclosed in U.S. Pat. No. 4,378,044 to Suchan. If jumping is not an option, an unscrewing machine built into the mold can unscrew the part from the core. Unscrewing molds are considered among the most complex of all molds, and are limited in their application to threads. The added complexity often limits the number of articles that could otherwise be molded with a single mold.

A collapsible core can provide undercuts by radially collapsing inward during mold closing and radially expanding outward during mold opening. One exemplary system is disclosed in U.S. Pat. No. 4,502,659 to Stephenson et al. The system incorporates a mold member with a socket-like head comprised of a plurality of segments each defining a portion of the mold cavity. During mold opening, the segments radially flare outward to provide clearance for the external undercut to be ejected from the mold. The advent of collapsible cores, including reverse collapsible cores and dovetail collapsible cores, advanced undercut molding in several respects; however, these devices and processes are associated with several shortcomings. For example, the tolerancing and fit between the segments are critical to producing flash-free molding (i.e., “flash” is the excess material attached to a molded product typically caused by the leakage of material between two surfaces of the mold). Further, collapsible cores are generally limited to cylindrical or radially symmetrical articles.

The aforementioned methods of producing articles with undercuts typically cannot be extended to increasingly complex shapes. Of particular interest to the present disclosure is for use in creating airflow diverter ducts. A set of exemplary vane like shapes are shown in FIGS. 1B and 1C. With reference to FIGS. 1A-1C, each of the part shapes are comprised of a plurality of vanes 16 generally shaped as curvilinear structures configured to redirect the air through a plurality of passageways 24, generally in a direction of arrow 18, to redirect air in a desired direction. FIG. 1C details that each of the plurality of vanes is associated with an undercut 20. The undercut 20 of FIG. 1C comprises a space beneath each of the vanes 16 adjacent a vertical axis 22 associated with a most rearward point of each of the vanes 16. A straight-pull mold is limited to removing an insert in a vertical direction from each of the passageways 24; thus, the insert cannot occupy the undercut and be removed through means commonly associated with a straight-pull mold. From the appearance of the exemplary shape, particularly the curvilinear structures of each of the plurality of vanes 16, it is readily apparent that aforementioned methods of producing articles with undercuts are insufficient to manufacture these and similarly complex articles.

United States Patent Publication No. 2007/0210472 to D′Inca et al. discloses a method for molding an article with a composite that requires compressing a sheet of premixed composite between two mold halves. After compression, the method undesirably requires further processing to remove excess material. Further, since the reference is concerned only with manufacturing the vanes or the blades (of a turbine), an undercut is not of concern, and standard compressive molding operations can be utilized.

Therefore, a need in the art exists for a tool used in a molding operation that is capable of producing complex articles having undercuts. A further need exists in the art to produce such articles using composites with relative ease. The properties of the composite should be fully preserved. The tool should not require more than minimal excess materials such as flash be removed from the article after the molding operation.

### SUMMARY OF THE DISCLOSURE

A primary object, feature, and/or advantage of the present disclosure is to improve on or overcome the deficiencies in the art.

Another object, feature, and/or advantage of the present disclosure is to provide a tool or insert used in a molding operation capable of more efficiently producing complex articles having undercuts. The tool or insert is advantageously removable from within the molded component after the molding operation.

Still another object, feature, and/or advantage of the present disclosure is reusability of the insert after the molding operation. Contrary to molding operations in which the insert is melted or otherwise destroyed from within the molded component to reveal the undercut, the present disclosure contemplates removing the insert in a non-destructible manner. Such reusability minimizes expense and lead time in manufacturing.

Still yet another object, feature, and/or advantage of the present disclosure is a system and method capable of producing a variety of non-uniform component shapes. The shapes need not be symmetrical, radially symmetrical, or otherwise uniform. A plurality of pieces can be positioned in an assembled configuration to comprise the insert. The plurality of pieces each have a geometry to be removed from within the molded component, often sequentially, after the molding operation. The geometry of the pieces, and the means by which the pieces are interlocked results in an article having an undercut with minimal excess material such as flash.

Another object, feature, and/or advantage of the present disclosure includes modularity when utilizing a plurality of inserts. One or more of the inserts can be interconnected via a bottom tool structure to create increasingly complex articles using advanced composite materials. The bottom tool structure has simple geometry for easy cleaning, upkeep, and reuse. Further, the bottom tool structure advantageously includes protrusion, pins, or other means to locate, orient, position and/or secure each of the inserts to the structure.

Still another object, feature, and/or advantage of the present disclosure is to provide a design in which the insert can quickly be removed from the molded component. The base assembly can include a post member that is drafted for easy removal from within the insert. The removal of the post member generates a cavity into which at least one of the pieces can be moved or collapsed to initiate the sequential removal of the pieces, and thus the insert. A bore can extend through the post member and provide for improved supply and/or removal of heat from the insert during or after the molding operation. Further, a connecting member can be disposed within a countersink associated with the post member and removably secured to a cap. The configuration provides improved interlocking of the pieces to reduce flash.

Another object, feature, and/or advantage of the present disclosure includes the ability to incorporate the device and system into a compression molding operation using zone-based active tool heating and cooling using air to manage temperature of the mold tool surface via arrayed heating of the ram and/or base, forced air heating and cooling using multiple airstreams, and heat removal with exhaust routes. Together with the central bore configured to supply and/or remove heat from the insert during or after the molding operation, the temperature of the molded component can be controlled with increased precision. Such precision maintains the mechanical and other physical properties of the molded material, which is of utmost importance when using advance composites during fabrication of ducting used to divert airflow.

These and/or other objects, features, and advantages of the present disclosure will be apparent to those skilled in the art. The present disclosure is not to be limited to or by these objects, features and advantages. No single embodiment need provide each and every object, feature, or advantage.

According to at least one aspect of the present disclosure, an improved device for producing a molded component having an undercut is provided. The device includes an insert comprised of a plurality of separate pieces individually removable from the molded component. One of the plurality of separate pieces is collapsible or movable into the cavity within the insert for subsequent removal from the molded component. The cavity can be created by removal of a base assembly having a post member. The remaining pieces are iteratively or sequentially collapsible into the cavity for subsequent removal from the molded component. Each of the pieces can have a different geometry. The pieces can be metallic, ceramic, a combination thereof, or of any suitable material to the demands of the molding operation.

One exemplary material of the pieces can comprise P20 tool steel. In contemplating other materials such as aluminum, copper, and/or beryllium copper, the ideal material transfers heat quickly and absorbs very little. Therefore, a high thermal conductivity and low heat capacity is preferable. The thermal diffusivity (i.e., the ratio of conductivity to capacity) can also be considered in light of the softness and cost of the material. Thus, aluminum has suitable thermal diffusivity, but is inherently soft. Beryllium copper is a preferable material, but is expensive to fabricate the pieces. The present disclosure contemplates that the pieces can be constructed from beryllium copper, but also embedded with copper and/or aluminum as appropriate. Further, the present disclosure contemplates printing the pieces using three-dimensional printing technologies as commonly known in the art.

In addition to material selection, the mass and geometry of the pieces is critical to reducing cycle time. The present disclosure contemplates several means by which to optimize mass and geometry. In an exemplary embodiment, the pieces 38 can be hollow while ensuring suitable contact patch to the heat source. The hollowing can be achieved through through-holes or three-dimensional printing with an internal cavity. In at least some aspects of the present disclosure, the hollow pieces can include a material with high thermal conductivity, including but not limited to aluminum, copper and/or beryllium copper.

According to at least one aspect of the present disclosure, a system for producing a molded component includes an insert configured to be removable from the molded component and having a plurality of pieces configured to be positioned into an assembled configuration. Each of the pieces is comprised of a plurality of contact surfaces each between at least two of the plurality of pieces in the assembled configuration, an outer boundary extending between the contact surfaces, an inner boundary extending between the contact surfaces and opposite the outer boundary, and an upper boundary opposite a lower boundary. The upper boundary and the lower boundary are separated by the outer boundary, the inner boundary, and the contact surfaces. The inner boundaries of the pieces collectively define a cavity within the insert in the assembled configuration. The outer boundaries of the pieces collectively define a periphery of the insert in the assembled configuration. The molded component is associated with the periphery of the insert. The pieces can be assembled such that each of the pieces is adjacent to exactly two other pieces.

Due to the relative dimensions of the insert and the molded component, the insert can be prevented from being wholly inserted or removed from the molded component in the assembled configuration. However, at least one of the pieces is removable from the molded component through the cavity. More particularly, the inner boundary of at least one of the pieces is sized to be slidable, movable, or collapsible into the cavity such that the piece is removable from the molded component through the cavity. The pieces can be configured to be sequentially removed from the molded component.

A base member is configured to be removably positionable adjacent the lower boundary of the pieces in the assembled configuration, and a post member extends upwardly from the base member. The post member is configured to be removably positioned within the cavity in the assembled configuration. The base member and the post member are removed from the insert prior to subsequent and/or sequential removal of the plurality of pieces from the molded component.

The system can further include an upper retention feature associated with the upper boundary of each of the pieces. The upper retention features collectively define an upper retention member of the insert. A counterposing retention member can be configured to removably connect with the upper retention member to interlock the plurality of pieces in the assembled configuration. The system can further include a lower retention feature associated with the lower boundary of each of the pieces. The lower retention features collectively define a lower retention member of the insert. A base retention feature can be associated with the base member and configured to removably connect with the lower retention member to interlock the plurality of pieces in the assembled configuration.

A plurality of inserts can be arranged into an array interconnected by a bottom tool structure. The molded component can include a matrix of cells. Each of the inserts is associated with one of the cells. The bottom tool structure can be operatively connected to a compression molding machine. In one embodiment, the compression molding machine further comprises a ram and a base that provide for active forced air heating and cooling of the molded component.

According to at least one aspect of the present disclosure, a mold system can include a mold and an array of inserts configured to be removably inserted into the mold. Each of the inserts comprises a plurality of pieces configured to be assembled, a cavity within the insert at least partially bounded by the pieces. The mold and the array of inserts produce a molded component having a plurality of cells each associated with an undercut. The undercuts of the molded component prevent removal of the inserts from the molded component. At least one of the pieces associated with each of the inserts is slidable, movable, or collapsible into the cavity so as to be removable from the molded component. The relative dimensions between the inserts and the undercuts can require the pieces of each of the inserts be removed through one of the plurality of cells of the molded component in sequence.

A post member extends through the cavity, is connected to a base member, and removable from within each of the inserts. The pieces, the base member, and the post member are configured to interlock to comprise each of the inserts. During removal, the post member is removed prior to removal of the pieces associated with the same insert. A bottom tool member can connect all of the inserts in the array. In an exemplary embodiment, the plurality of cells of the molded component are arranged in a rectangular matrix.

According to at least one aspect of the present disclosure, a method for molding items is provided. The method includes the step of performing a molding operation to produce a molded component. An insert having a plurality of pieces is removed from the molded component. To do so, a post member extending through the insert is removed, thereby creating a cavity. A first piece is moved into the cavity of the insert, thereby making the first piece removable from the molded component. The first piece is removed from the molded component, thereby creating an updated cavity. A second piece is moved into the updated cavity, thereby making the second piece removable from the molded component. The second is removed from the molded component. The method can be iteratively repeated for each of the pieces of the insert.

The method can further comprise the step of removing a retention cap configured to interlock the plurality of pieces. The method can further include the step of trimming a crown portion of the molded component to expose a plurality of cells extending through the molded component. Further, an array of the inserts can be positioned on a bottom tool structure via pins associated with the bottom tool structure and corresponding structures associated with the insert.

### BRIEF DESCRIPTION OF THE DRAWINGS

Illustrated embodiments of the disclosure are described in detail below with reference to the attached drawing figures, which are incorporated by reference herein, and where:

FIG. 1A illustrates a perspective view of airflow diverter duct as commonly known in the art.

FIG. 1B illustrates a cross-sectional view of the airflow diverter duct of FIG. 1A taken across section lines 1B-1B.

FIG. 1C illustrates a detailed view of a portion of FIG. 1B within circle 1C-1C.

FIG. 2 illustrates an exploded view of several components associated with a molding operation in accordance with an exemplary embodiment of the present disclosure. The molding operation can produce a molded component using an array of inserts positioned on a bottom tool structure. In an exemplary embodiment, a trimming operation can be performed after the molding operation to remove crown portions associated with the molded component.

FIG. 3 illustrates a perspective view of an insert in an assembled configuration in accordance with an exemplary embodiment of the present disclosure.

FIG. 4 illustrates an exploded view of an insert in accordance with an exemplary embodiment of the present disclosure.

FIG. 5A illustrates a perspective view of plurality of pieces of an insert in accordance with an exemplary embodiment of the present disclosure. The pieces are positioned in an assembled configuration.

FIG. 5B illustrates an exploded view of a plurality of pieces of an insert in accordance with an exemplary embodiment of the present disclosure.

FIG. 6A illustrates a perspective view of a base assembly in accordance with an exemplary embodiment of the present disclosure.

FIG. 6B illustrates a perspective view of a base assembly in accordance with an exemplary embodiment of the present disclosure.

FIG. 6C illustrates a cross-sectional view of the base assembly of FIG. 6A taken along section lines 6C-6C.

FIG. 7 illustrates a cross-sectional view of an insert in an assembled configuration within a mold in accordance with an exemplary embodiment of the present disclosure. The molded component can be formed between a portion of the insert and a portion of the mold.

FIG. 8 illustrates an exploded view of a mold and insert in accordance with an exemplary embodiment of the present disclosure. The insert can be configured to be used singularly in conjunction of a mold comprised of two halves, as illustrated, or used in an array of inserts within a mold cavity, as illustrated in FIGS. 2, 11A and 11B.

FIG. 9A illustrates a top plan view of a plurality of pieces in accordance with an exemplary embodiment of the present disclosure.

FIG. 9B illustrates a top plan view of a plurality of pieces in a first stage of removal in accordance with an exemplary embodiment of the present disclosure. Piece B is moved or collapsed inwardly within a cavity created by a removed post member.

FIG. 9C illustrates the top plan view of FIG. 9A in a second stage of removal in accordance with an exemplary embodiment of the present disclosure. Piece A is moved or collapsed inwardly within an updated cavity.

FIG. 9D illustrates the top plan view of FIG. 9A in a third stage of removal in accordance with an exemplary embodiment of the present disclosure. Piece C is moved or collapsed inwardly within a further updated cavity.

FIG. 9E illustrates the top plan view of FIG. 9A in a fourth stage of removal in accordance with an exemplary embodiment of the present disclosure. Piece D is moved or collapsed inwardly within a still further updated cavity.

FIG. 10A illustrates a perspective view of a molded component in accordance with an exemplary embodiment of the present disclosure. The molded component includes a crown portion that can be removed via a trimming operation.

FIG. 10B illustrates a perspective view of the molded component of FIG. 10A following a trimming operation to remove the crown portion.

FIG. 11 illustrates a perspective view of a portion of a molding operation in accordance with an exemplary embodiment of the present disclosure. An array of the plurality of inserts are operably disposed within a compression molding operation using air to actively heat and cool the tool.

### DETAILED DESCRIPTION

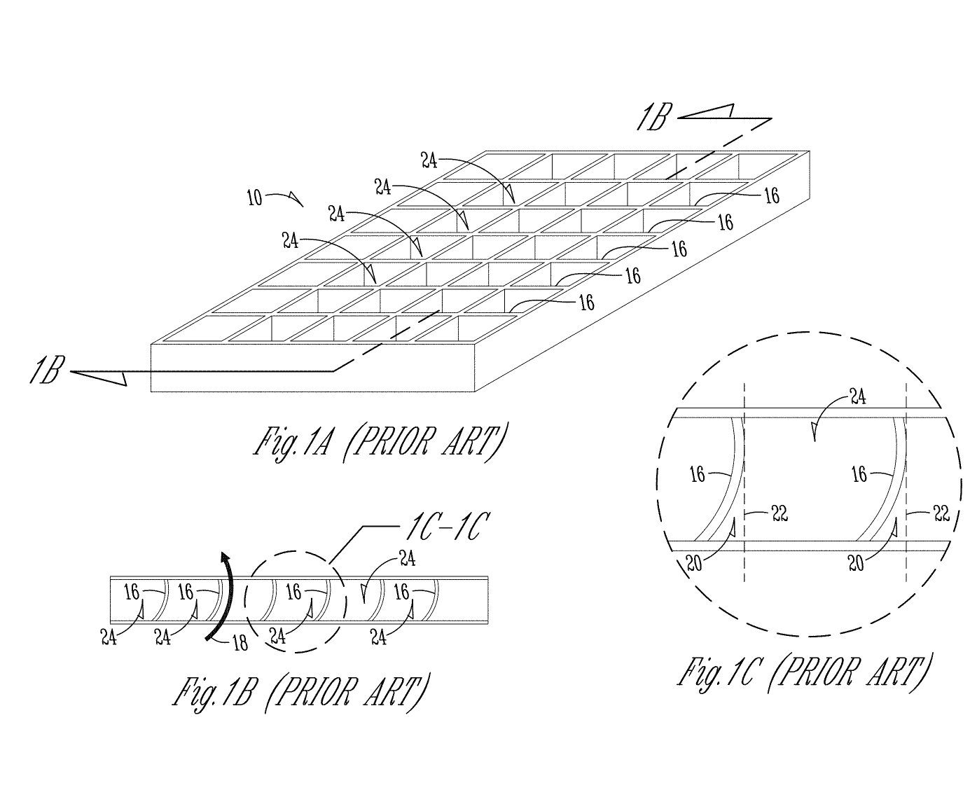

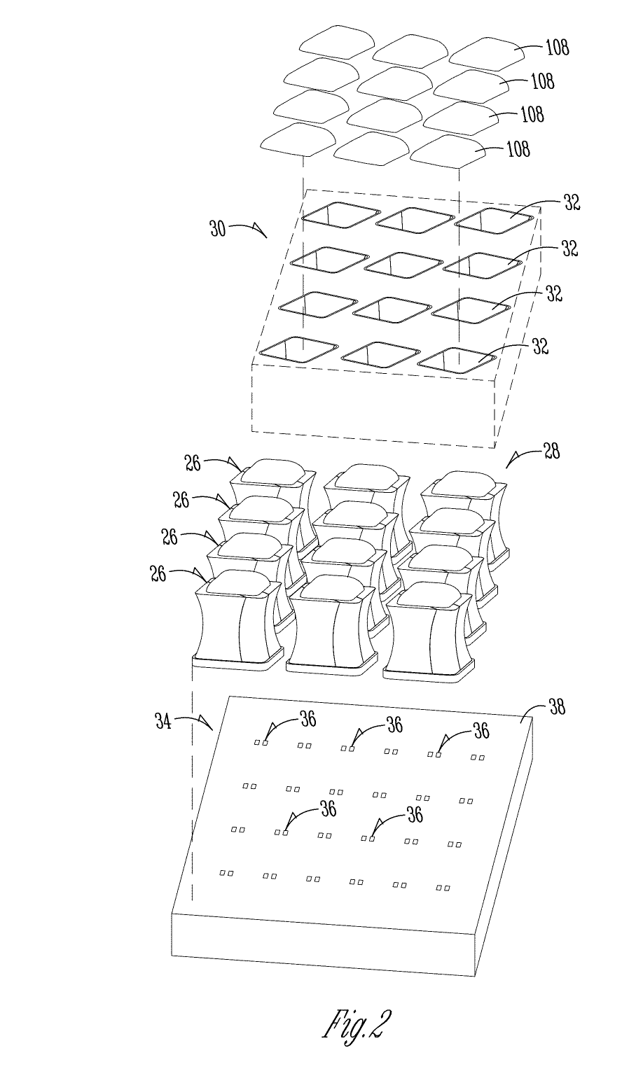

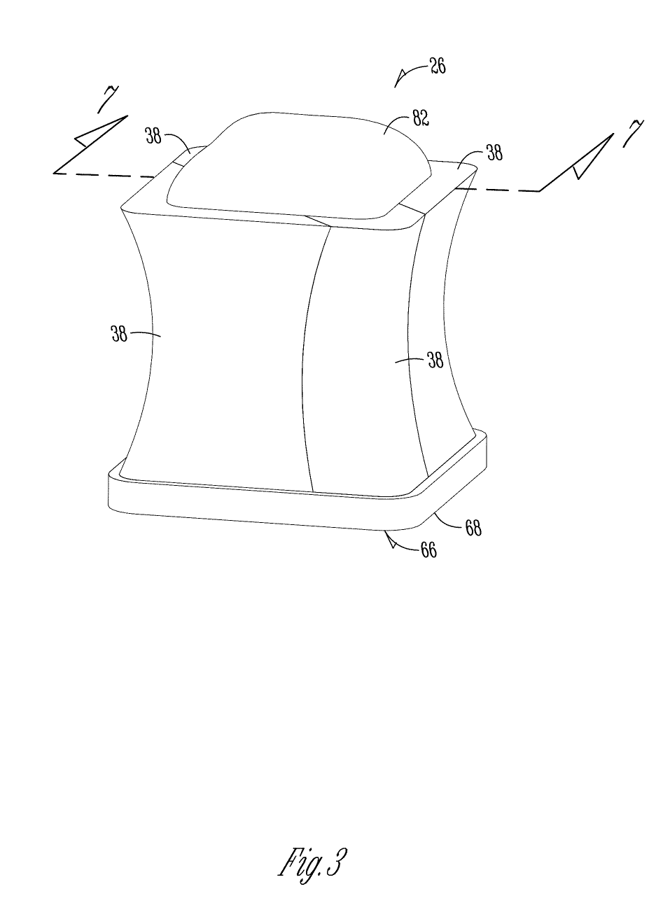

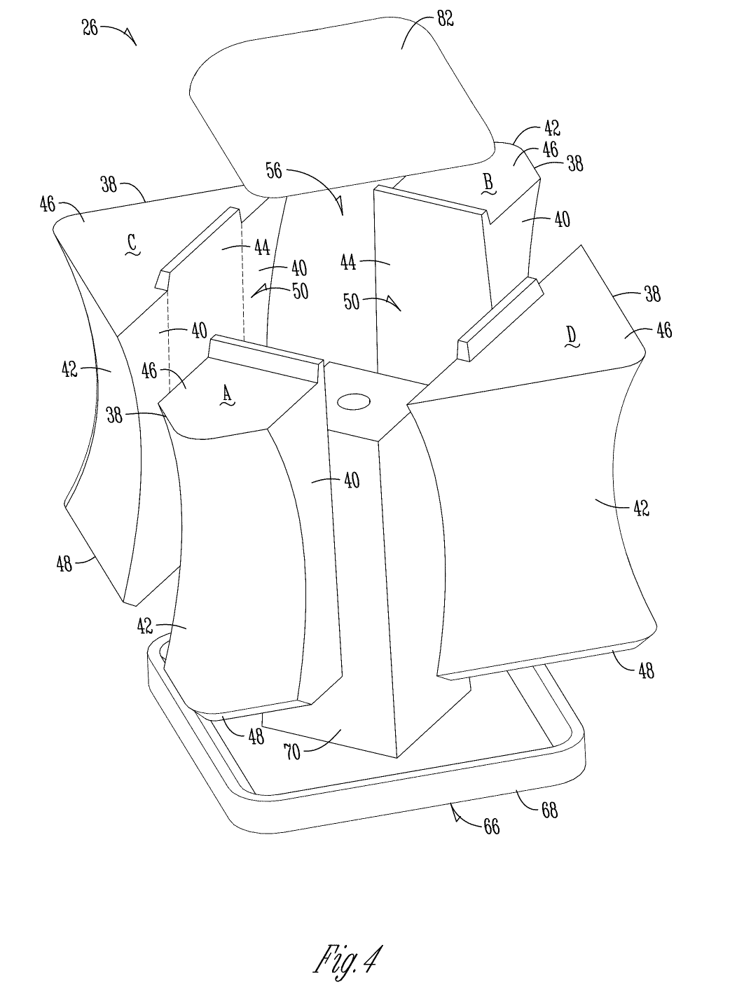

In molding operations configured to produce mold components with an undercut, such as the component 10 illustrated in FIG. 1A, each of the passageways or cells 24 of the molded component can be associated with a removable insert. Referring to FIG. 2, a plurality of inserts 26 can be incorporated to produce a molded component 30 with a plurality of cells 32. In the illustrated embodiment of FIG. 2, the plurality of inserts 26 are arranged in a rectangular array 28. In another exemplary embodiment, the array might be circular, triangular or of any other suitable arrangement or spatial relationship without deviating from the objects of the present disclosure. Furthermore, the present disclosure contemplates an insert 26 can be used singularly within a mold cavity.

In embodiments where a plurality of inserts 26 are incorporated, each of the plurality of inserts 26 is configured to interface to a bottom tool structure 34. The bottom tool structure 34 is generally a plate-like structure with geometries 36 configured to position, orient, and/or secure each of the inserts 26. In one exemplary embodiment illustrated in FIG. 2, the geometries 36 can each include a pair of posts or pins raised from an upper face 38 of the bottom tool structure 34. The posts or pins create an interference fit with a pair of indentations or pinholes (not shown) associated with a base member 68 of the base assembly 66 of each of the inserts 26. In another exemplary embodiment, the geometries can each include a toroidal depression configured to create an interference fit with a boss structure extending from the base member 68 of each of the inserts 26. The plate-like structure and simple geometries 36 of the bottom tool member 34 provide for, among other advantages, easy installation and removal of the inserts 26 prior to and after the molding operation, respectively, and easy cleaning of any residual molding material after the molding operation.

As commonly known in compression molding and as disclosed herein, the molding operation is generally associated with a ram and a base. In embodiments wherein one or more inserts 26 are operably connected to the bottom tool structure 34, the bottom tool structure 34 is removably secured to the base of the compression molding machine.

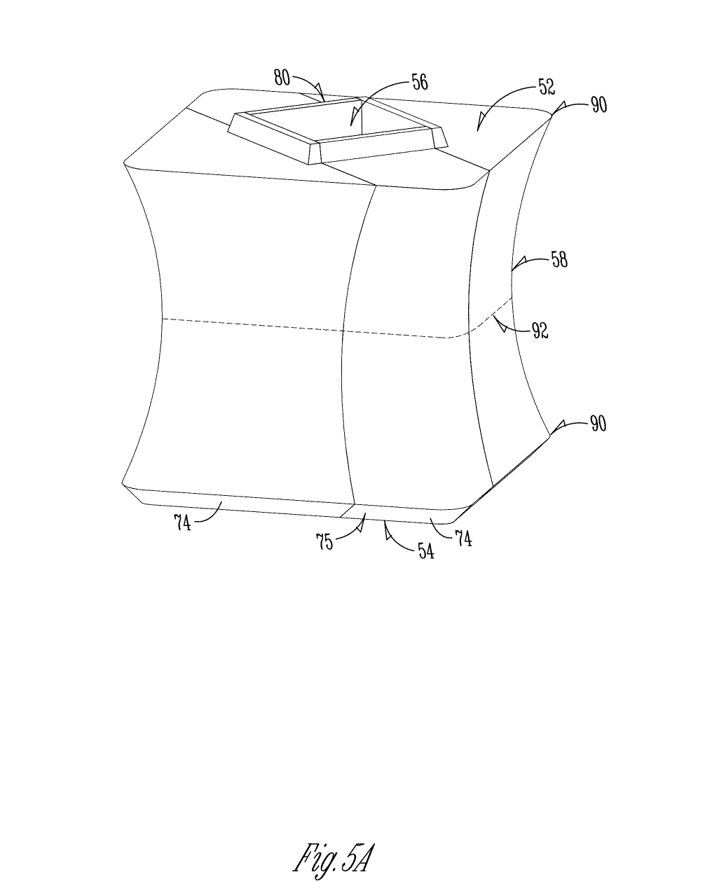

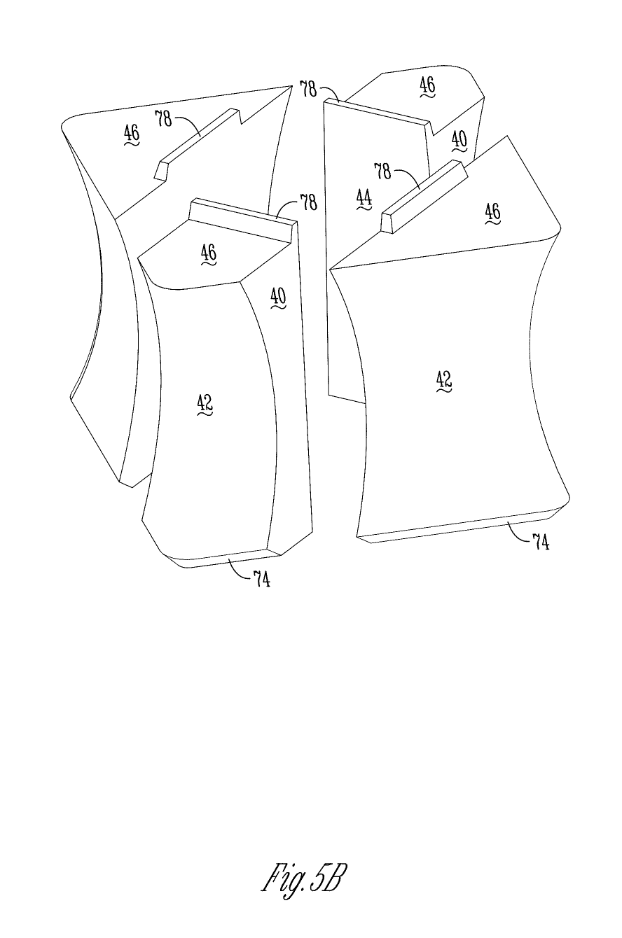

One of the primary objects and advantages of the present disclosure includes the insert 26 being removable from the molded component 30 having an undercut. To achieve this object and advantage, the insert 26 is comprised of a plurality of pieces 38. Referring to FIGS. 3 and 4, one exemplary insert 26 is illustrated. The plurality of pieces 38 is configured to be positioned into an assembled configuration, as illustrated in FIG. 3. The insert 26 and/or any number of the pieces 38 can be metallic, ceramic, a combination thereof, or of any suitable material to the demands of the molding operation. Furthermore, while one exemplary insert with pieces of a particular geometry is described in detail, the pieces can include any number of geometries without deviating from the objects of the present disclosure. More than one of the pieces can have the same geometry, or all of the pieces can have a different geometry.

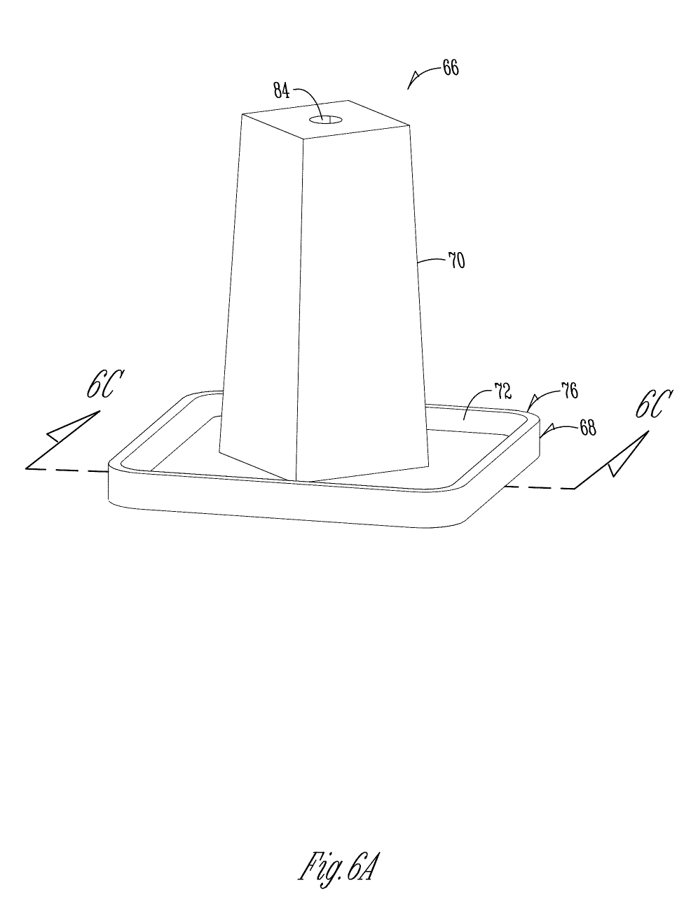

Each of the plurality of pieces 38 is comprised of a plurality of contact surfaces 40, an outer boundary 42, an inner boundary 44, an upper boundary 46, and a lower boundary 48. The contact surfaces 40 are each between at least two of the plurality of pieces 38 in the assembled configuration. With references to FIGS. 4 and 5B, the contact surfaces 40 of Pieces A and B include opposing side surfaces adjacent Pieces C and D. The contact surfaces 40 of Pieces C and D include portions of an inner surface 50 adjacent Pieces A and B. The contact surfaces 40 and positioning of the pieces can be such that any one pieces is adjacent or abutting exactly two of the other pieces. The outer boundary 42 of each of the pieces 38 extends between the contact surfaces 40 of each of the pieces 38 and generally external to the insert. The inner boundary 44 of each of the pieces 38 extends between the contact surfaces 40 of each of the pieces 38 opposite the outer boundary 42. Thus, in the illustrated embodiment of FIG. 4, the inner boundary 44 of Pieces A and B includes an entire inner surface 50. With particular reference to Piece C, the inner boundary 44 of Pieces C and D include portions of an inner surface 50 between the contact surfaces 40. The upper boundary 46 is opposite the lower boundary 48, and each are defined between the outer boundary 42, the inner boundary 44, and the contact surfaces 40, as illustrated in FIGS. 4 and 5B. Further, as best illustrated in FIG. 5A, the inner boundaries 44 of the plurality of pieces 38 collectively define a cavity 56 within the insert 26 in the assembled configuration. The outer boundaries 42 of the plurality of pieces 26 collectively define a periphery 58 of the insert 26 in the assembled configuration. The upper boundaries 46 of the plurality of pieces collectively define an upper surface 52 in the assembled configuration. The lower boundaries 48 of the plurality of pieces collectively define a lower surface 54 in the assembled configuration.

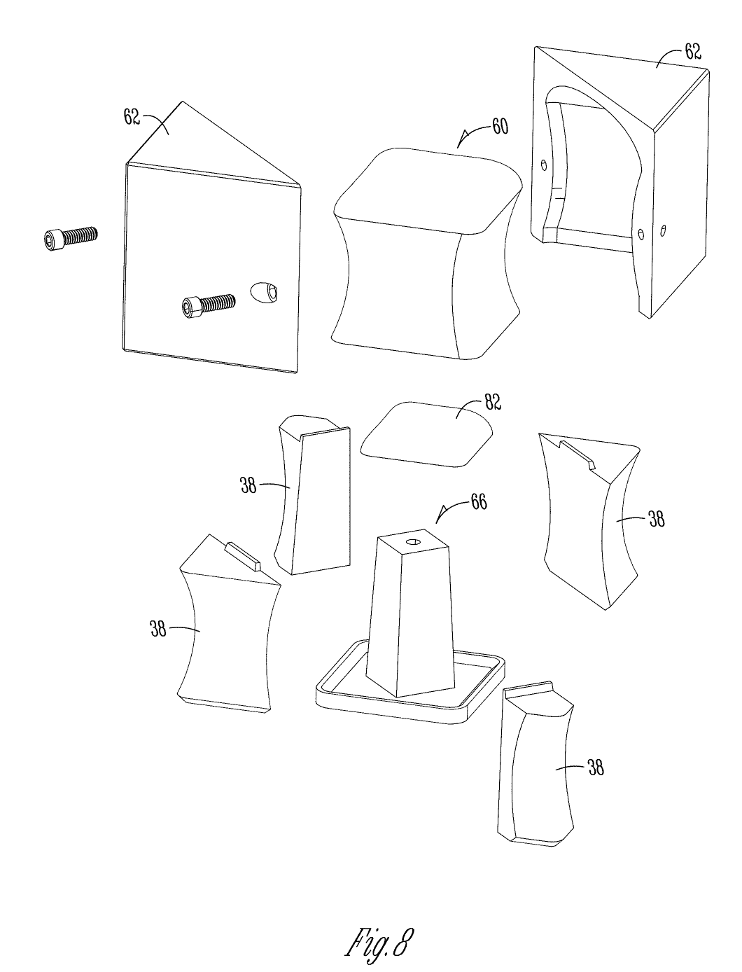

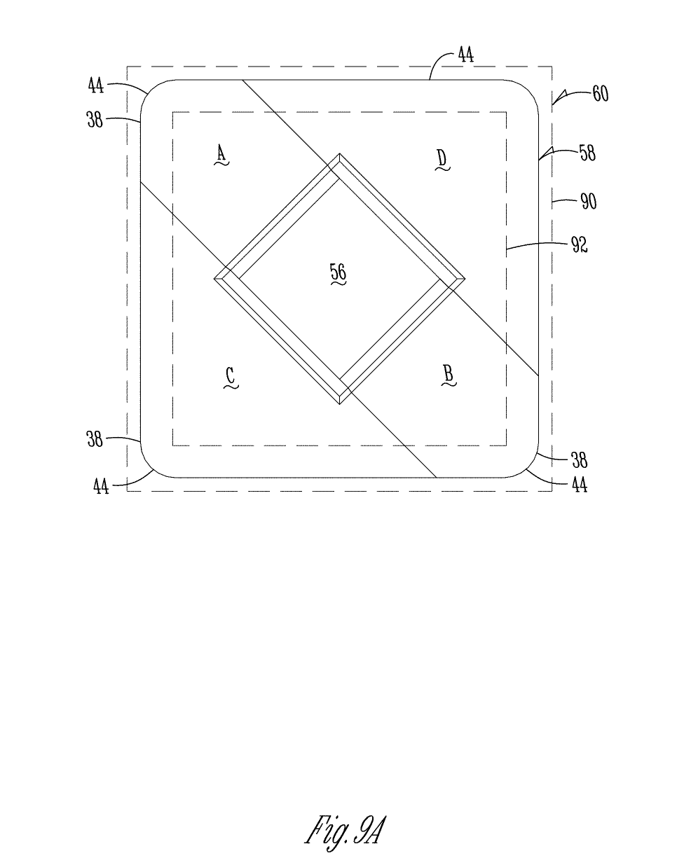

The molded component is associated with the periphery 58 of the insert 26. More particularly, when the insert 26 is disposed within a mold of the molding operation, the material(s) are molded and compressed about the periphery 58 of the insert 26 such that the molded component generally is shaped to periphery 58 and the mold. FIG. 7 illustrates a cross-sectional view of the insert 26 of FIG. 3 disposed within a mold 62. At least a portion of the molded component 60 is disposed between the pieces 38 and the mold 62. Furthermore, the molded component 60 includes the undercut 64, generally represented by the arcuate portions of the molded component 60 extending outward (if the direction of component removal is in the direction of arrow 66). It can be appreciated that, absent the insert 26 with the advantages of the present invention, a typical mold insert would not be removable from the molded component 60 due to the undercut 64, absent destructive, complex, and/or expensive means.

Referring to FIG. 3, the plurality of pieces 38 are configured to be positioned into an assembled configuration. To do so, the pieces 38 are positioned adjacent to one another as illustrated. To create a temporarily unified insert 26, the present disclosure includes improved devices and methods for interlocking the pieces together. The improved devices and methods generate a sufficiently secure and tight fit between the pieces to avoid flash lines during molding while permitting the removal of the insert 26, which will be discussed below. The temporary interlocking of the pieces 38 to form the insert 26 is accomplished by a base assembly 66 having a base member 68 and a post member 70 extending from the base member 68. The base member 68 and the post member 70 can be integrally formed or otherwise secured through means commonly known in the art.

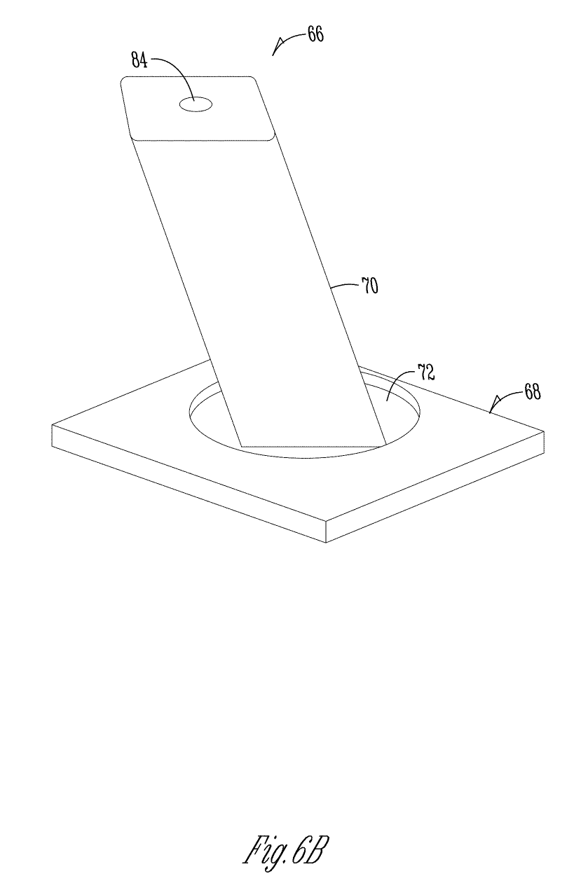

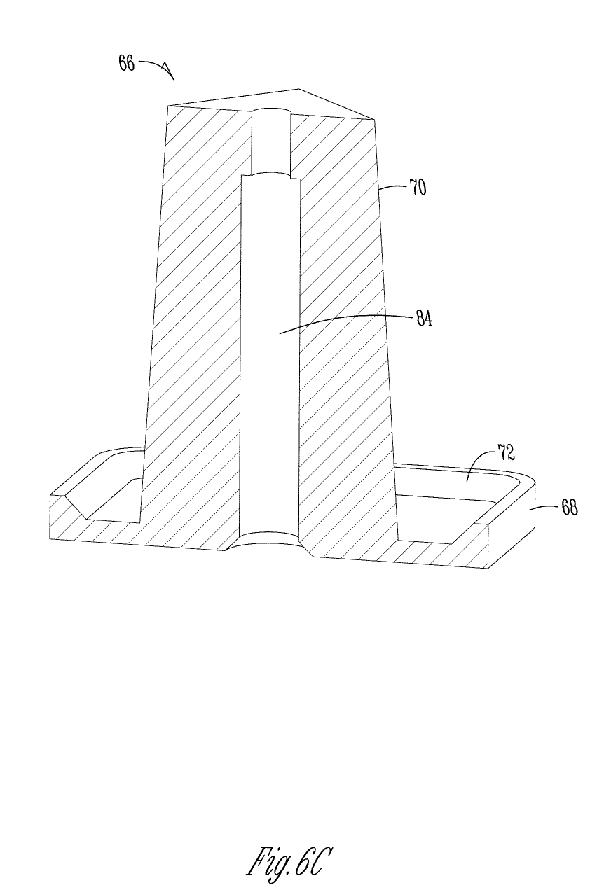

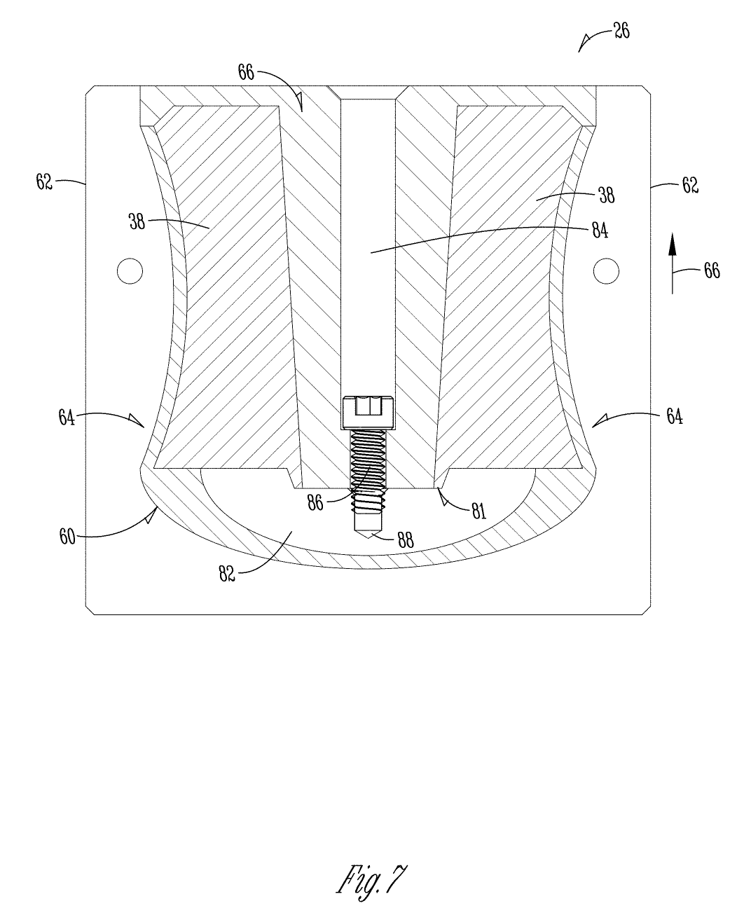

One exemplary base assembly 66 is illustrated in FIGS. 6A and 6C. The base member 68 is configured to be removably positionable adjacent the lower boundary 54 of each of the pieces 38 in the assembled configuration. A base retention feature 72 is comprised of an angled surface 72 associated with an upwardly extending flange 76 of the base member 68. Lower retention features 74 (FIGS. 5A and 5B) associated with each of the pieces 38 at the lower boundary 54 collectively define a lower retention member 75 of the insert 26. In the illustrated embodiment of FIGS. 5A and 5B, the lower retention features 74 include chamfered surfaces. In the assembled configuration, the base retention feature 72 creates an interference fit with the lower retention member 75. Based on the dimensions of the lower boundaries 54 of each of the pieces 38, the base retention feature 72, and the lower retention features 74, the pieces 38 are directly adjacent to and/or directly abut one another and the inner boundaries 44 are directly adjacent to and/or directly abut the post member 70. Another exemplary base assembly 66 is illustrated in FIG. 6B. The base assembly 66 of FIG. 6B is similar to that of FIGS. 6A and 6C insomuch as including a base member 68 and a post member 70 extending from the base member 68. Whereas the base retention feature 72 of FIGS. 6A and 6C is an angled surface, the base retention feature 72 of FIG. 6B can alternatively include a circular channel associated with the base member 68 and configured to create an interference fit with an arcuate boss of extending from the lower boundary 54 of each of the pieces 38. Furthermore, the base assemblies 66 of FIGS. 6A-6C show the post member 70 can be substantially perpendicular to the base member 68, or oriented at an angle relative to the base member 68. In preferred embodiments, the post member 70 is at least slightly drafted to provide for easy removal from the cavity 56 of the insert 26.

With reference to FIGS. 3, 4, 5A and 5B, each of the pieces 38 can further include an upper retention feature 78 associated with the upper boundary 46. In the illustrated embodiment, the upper retention features 78 include a lip-like raised area extending upwardly from the upper boundaries 46. In the assembled configuration, the upper retention features 78 collectively define an upper retention member 80 of the insert. A counterposing retention member 82 is configured to removably connect with the upper retention member 80 to interlock the pieces 38 in the assembled configuration. In a preferred embodiment, the counterposing retention member 82 is a cap having a recess in which the upper retention member 80 is disposed in the assembled configuration.

Thus, in the illustrated embodiment of FIGS. 4 and 5A, the upper retention features 78 of each of the pieces 26 collectively define the upper retention member 80. The cap 82 of FIG. 4 has a square-shaped recess 81 (FIG. 7) on an underside, the recess being sized to the upper retention member 80. When the cap 82 is disposed on the upper retention member 80, as illustrated in FIGS. 3 and 7, the cap 82 interlocks the pieces 38. Consequently, the plurality of pieces 38 are interlocked from below by the base assembly 66 and from above by the cap 82. The result is a temporarily unified insert 26 with a periphery 58 contoured to the molded component. In exemplary embodiments, the periphery 58 can include at least one arcuate structure having an undercut.

To further interlock the plurality of pieces 38 together, the post member 70 of the base assembly 66 can include a bore 84 extending through the post member 72. With reference to FIGS. 6C and 7, the bore 84 extends axially through the post member 72. In exemplary embodiments, the bore 84 is countersunk so as to receive a connecting member 86 such as a screw or other fastener. A void 88 within the counterposing retention member 82 (e.g., the cap) is aligned with the bore 84 in the assembled configuration. The connecting member 86 is positioned within the bore 84 and pulls the counterposing retention member 82 towards the post member 70, which pulls the counterposing retention member 82 against the retention member 80 of the insert 26, thereby tightening the pieces 26 both together and against the base assembly 66. The present disclosure further contemplates that heat can be supplied to or removed from the insert 26 via the bore 84 during or after the molding operation.

The method by which the insert 26 is removed from a molded component will now be explained. One or more inserts in the assembled configuration are inserted within a mold. As disclosed, a singular insert 26 can be inserted into a mold 62, similar to the embodiment illustrated in FIG. 7, or a plurality of inserts 26 can be interconnected via a bottom tool structure 38, similar to the embodiment illustrated in FIG. 2. The plurality of inserts 26 can be arranged in an array 28 or matrix, or in any other suitable configuration to meet the demands of a specific molding operation.

The molding operation is performed, in which material is heated and compressed via a ram over the cap(s) 82 of the one or more inserts 26. The cap(s) 82 can be dome-shaped so as to facilitate material flow in between the insert 26 and the mold 62 and/or between each of the inserts 26. The dome shape can further minimize material usage, which advantageously provides for lower material costs. The material is heated and compressed in between the insert 26 and the mold 62 and/or between each of the inserts 26. The cap 82 can be designed to advantageously direct flow of the heated material to control knit lines and/or overall mold flow. For example, controlling overall mold flow can advantageously orient and/or align fibers within the composite matrix, which can enhance mechanical properties of the fiber-reinforced composite.

After the molding operation is complete, the one or more inserts 26 and the molded component are removed from the mold. In certain embodiments, the bottom tool member 34 is used, thereby resulting in the molded component with the one or more inserts 26 disposed within the same. As previously disclosed, if an undercut is associated with the molded component, a typical mold insert cannot be removed from the same.

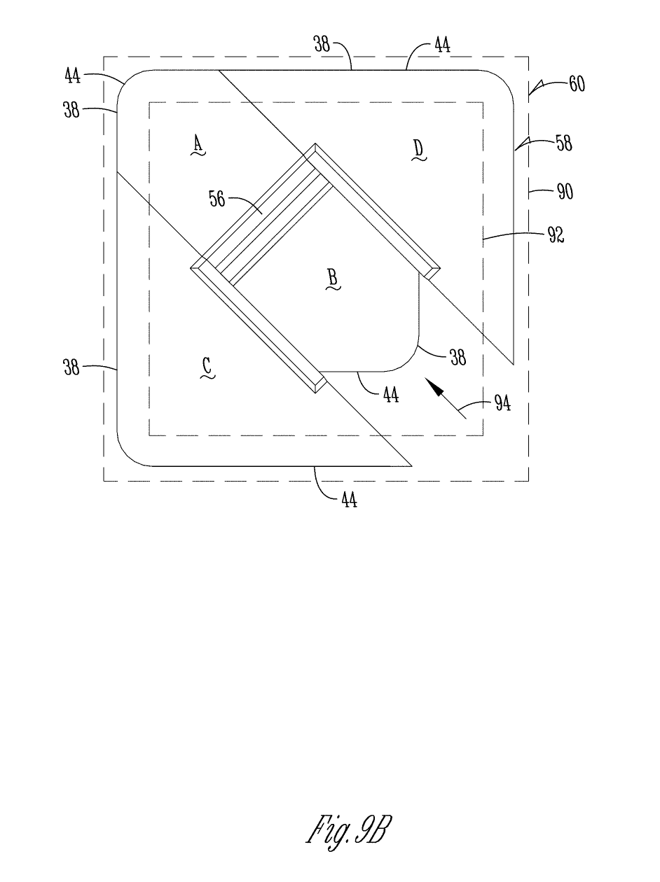

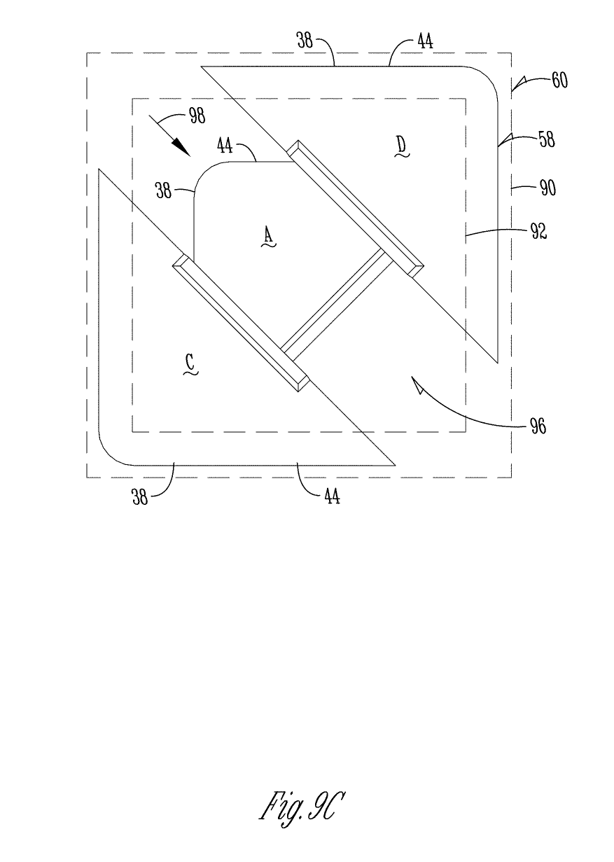

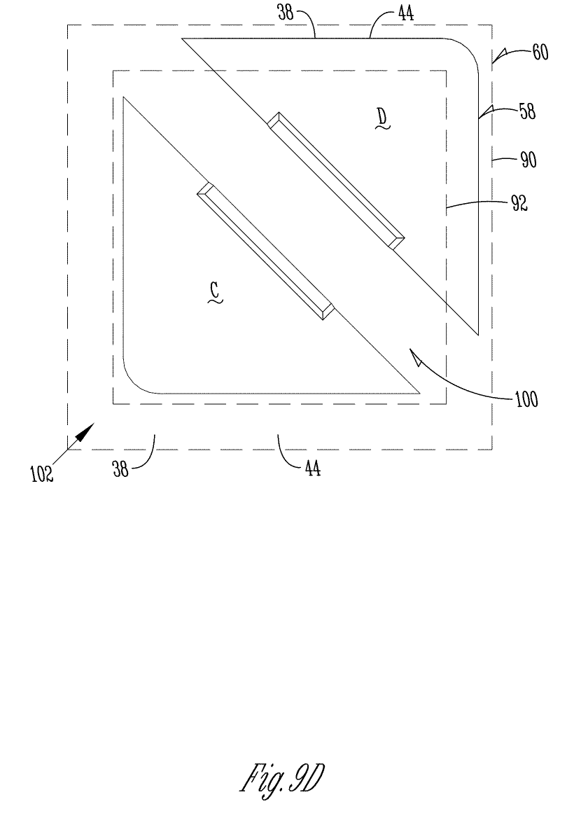

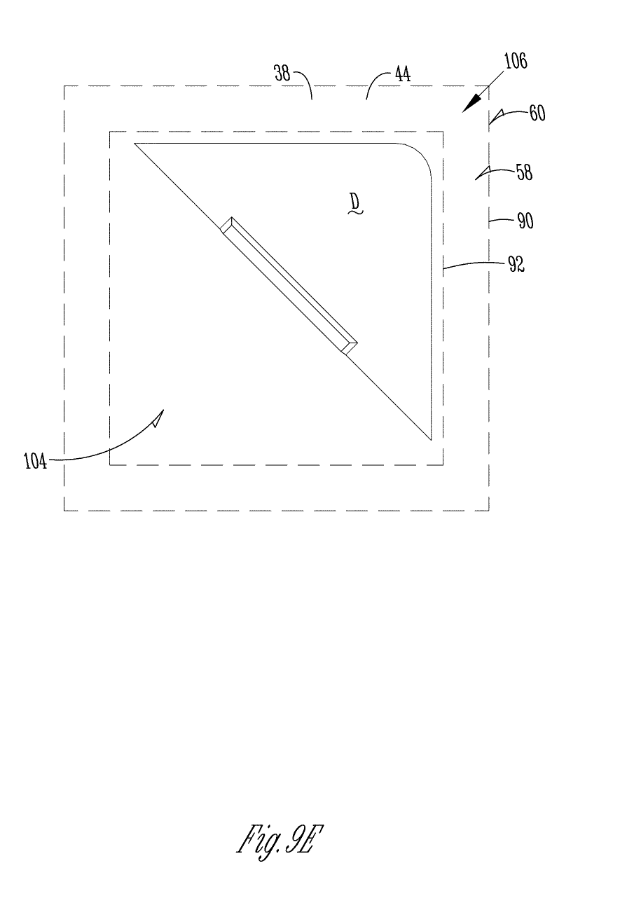

Referring to FIG. 7, the base assembly 66 is removed from the insert 26. To do so, the connecting member 86 is disconnected from the void 88, preferably by unscrewing a countersunk screw to disengage threads associated with the void 88. The connecting member 86 is removed from the bore 84. The shape of the post member 70 of the base assembly 66, particularly a taper or draft, permits the base assembly 66 to be slidably removed from the insert 26. The resulting configuration is similar to that of FIG. 5A and 9A, with the exception that the mold component 60 will surround the periphery 58 of the insert 26 and the counterposing retention feature 80. Because the base assembly 66 has been removed, the plurality of pieces 38 are now accessible.

In an alternative exemplary embodiment, a post member is not required. In such an embodiment, at least one of the pieces will not be associated with an undercut such that it can be slidably removed from the molded component. Consider the insert 26 of FIG. 3 wherein at least one of the pieces 38 comprising the insert 26 alternatively has a vertically planar (or outwardly tapering) outer boundary 42. With a vertically planar outer boundary 42, the piece 38 is a square or rectangular when viewed in top plan. The square or rectangular cross section permits the piece 38 to be slidably removed from the molded component due to the lack of undercut. The removal of the piece creates an initial cavity, after which the remaining pieces are removed in accordance with the present disclosure disclosed herein.

Referring now to FIGS. 5A, 7, 9A-9E, the molded component 60 has a widest portion 90 and a narrowest portion 92, which is generally contoured to the periphery 58 of the insert 26; the difference between the widest portion 90 and the narrowest portion 92 includes the undercut 64. The widest portion 90 and narrowest portion 92 of the insert 26 are reflected in the top plan views of FIGS. 9A-9E. As illustrated in FIGS. 9A-9E, the periphery 58 of the insert 26 is larger than the narrowest portion 92 of the molded component 60. Thus, the entire insert 26 (i.e., Pieces A-D as a singular structure) cannot be removed at the same time. Yet, the removal of the post member 70 of the base assembly 66 creates the cavity 56 within the insert 26. The cavity 56 is at least partially bounded by the plurality of pieces 38.

The size and shape of the cavity 56 and the pieces 38 are such that at least one of the pieces 38 can slidably move into the cavity 56. With reference to FIG. 9B, Piece B slides, moves, or collapses in the direction of arrow 94 into the cavity 56. Piece B is sized and shaped to move within the cavity 56 such that the outer boundary 44 of Piece B is within the narrowest portion 92 of the molded component 60, as illustrated in FIG. 9B, thereby making Piece B removable from the molded component 60. Thereafter, Piece B is removed from the cavity 56, which, in turn, creates an updated cavity 96. The updated cavity 96 includes the cavity 56 and the vacancy created by the removed Piece B. In other words, a portion of the updated cavity 96 includes the cavity 56. Referring now to FIG. 9C, Piece A is sized and shaped to move within the updated cavity 96 in the direction of arrow 98 such that the outer boundary 44 of Piece A is within the narrowest portion 92 of the molded component 60, thereby making Piece A removable from the molded component 60. Once Piece A is removed from the updated cavity 96 of the molded component 60, a further updated cavity 100 is created. The further updated cavity 100 includes the updated cavity 96 and the vacancy created by the removed Piece A.

Next, Piece C is moved within the further updated cavity 100 in a direction of arrow 102 such that the outer boundary 44 of Piece C is within the narrowest portion 92 of the molded component 60, thereby making Piece C removable from the molded component 60, as illustrated in FIG. 9D. Again, once Piece C is removed from the updated cavity 100 of the molded component 60, a still further updated cavity 104 is created. The still further updated cavity 104 includes the further updated cavity 100 and the vacancy created by the removed Piece C. Finally, Piece D is moved within the still further updated cavity 104 in a direction of arrow 106 such that the outer boundary 44 of Piece D is within the narrowest portion 92 of the molded component 60, thereby making Piece C removable from the molded component 60, as illustrated in FIG. 9E. The insert 26 has been quickly and effectively removed from the molded component 60. Further, the integrity of the pieces 38 is intact such that the pieces 38 can be reused in subsequent molding operations.

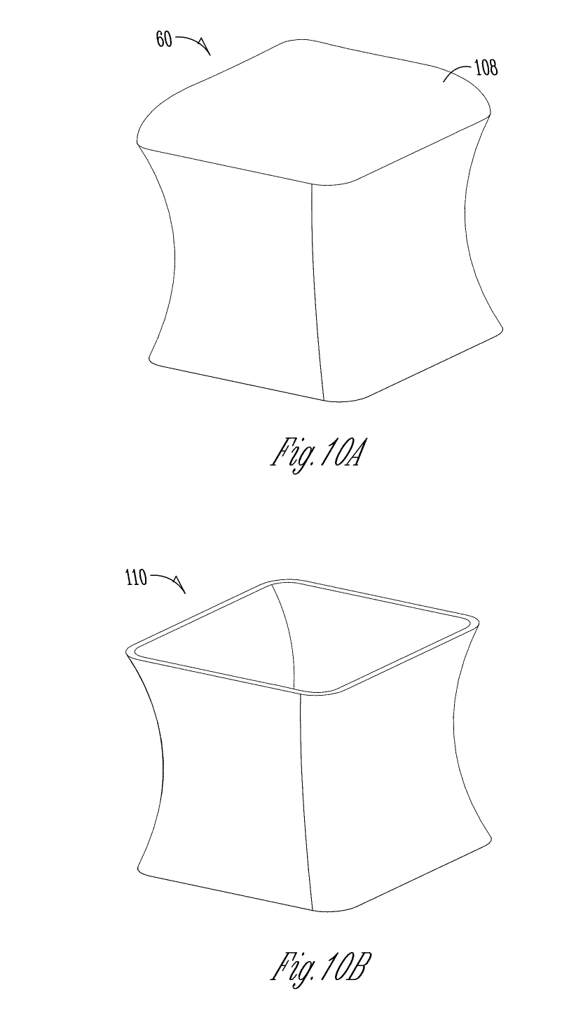

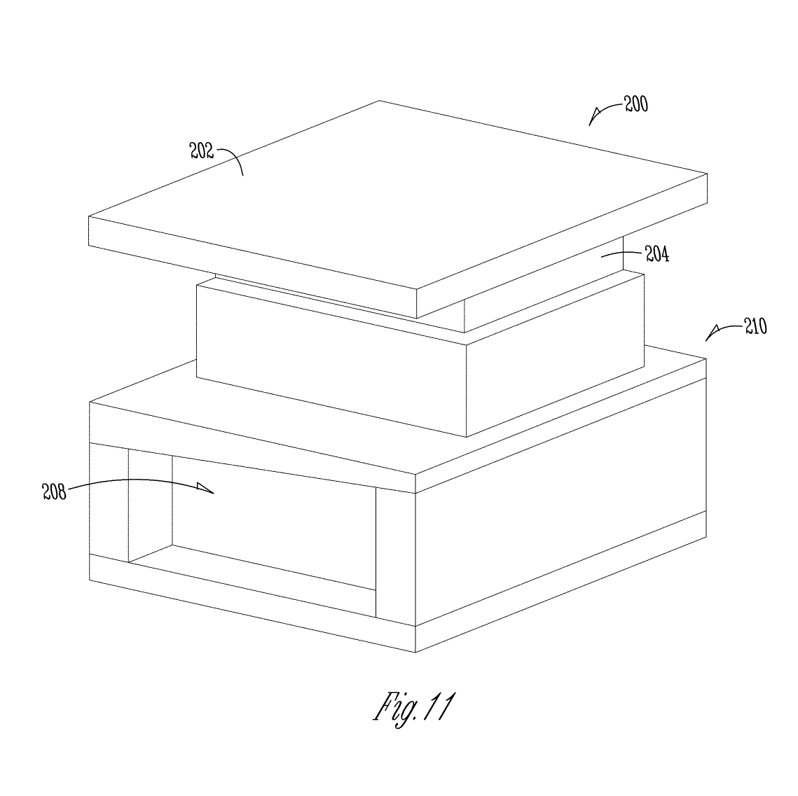

In some embodiments, after the final piece 38 is removed, the cap 82 remains within the molded component, as illustrated in FIG. 10A. Such a configuration is dependent, at least in part, on the relative dimensions of the cap 82 and the narrowest portion 92. In such an embodiment, the molded component 60 can include a crown portion 108 contoured to the cap 82. The crown portion 108 can be a thin layer designed to be trimmed off with a cutting operation. Once the crown portion 108 and cap 82 are trimmed, the molded component 110 of FIG. 10B results. In other embodiments, the cap 82, if dimensioned and/or shaped to do so, can be removed through the final cavity of the molded component 60. In such an embodiment, the trimming operation is limited to the crown portion 108.

From the above method of removing the insert 26 from the molded component 60, it is readily appreciated that the primary objects and advantages of the present disclosure are achieved by providing an insert 26 having a plurality of separate pieces 38 individually removable from a cavity 56/96/100/104 within the insert 26. In doing so, each one of the plurality of separate pieces 38 is slidable, movable, or collapsible or movable into the cavity 56/96/100/104 prior to subsequent removal. While the exemplary embodiment includes four pieces, any number of pieces can be utilized without deviating from the objects of the present disclosure. The present disclosure contemplates two, three, five, six, seven or greater pieces can be designed to be iterative or sequentially movable within a cavity then subsequently removed from the molded component.

Furthermore, in the exemplary embodiment, Pieces A and B and Pieces C and D were substantially the same. Based on such design, while the disclosure indicates Piece B is moved into the cavity 56 first, followed by Piece A, this need not be the case. In the exemplary embodiment described, Piece A could have been moved into the cavity 56 first. Based on relative dimensions, however, Pieces C and D must remain within the molded component until after both Pieces A and B were removed, after which either Piece C or Piece D could be removed followed by the other. In such a respect, there is a sequential nature to the order in which the pieces must be removed: (i) Piece A or B, (ii) the remaining of Piece A or B, (iii) Piece C or D, and (iv) the remaining of Piece C or D. Furthermore, it can be readily appreciated that the base assembly 66, and more particularly the post member 70, must be removed prior to removal of the plurality of pieces 38 associated with the same insert 26.

While the exemplary embodiment discloses symmetry such that Pieces A and B and Pieces C and D are substantially the same geometry, the present disclosure contemplates that each piece could have a different geometry. In such embodiments, the sequential order in which the pieces must be removed could be more constrained. Together with embodiments in which greater than four pieces are utilized, the insert could become increasingly complex. Yet utilizing greater than four pieces, especially smaller pieces, can provide for molded components with undercuts of increasingly complex shape.

The present disclosure emphasizes that the present invention can be used to any periphery having an undercut, with the molded component 60 being but one exemplary embodiment. Thus, while the disclosed mold component 60 is a rectangular prism including a periphery 58 comprised of four arcuate surfaces, not all sides need to include undercuts. In a preferred embodiment, two opposing sides of the insert can be substantially planar, and the two remaining opposing sides of the insert can be arcuate and parallel. Each of the inserts being an arcuate structure results in a geometry similar to vanes 16 of the component 10 illustrated in FIGS. 1A-1C such that the molded component is airflow diverter duct.

In the context of producing airflow diverter ducts or similar molded components having a matrix of cells 32 (e.g., 30 of FIG. 2), a plurality of inserts 26 can be arranged into an interconnected array 28. Each of the plurality of inserts 26 is associated with one of the cells 32. As used herein, the term “interconnected array” means the inserts 26 are commonly connected to the bottom tool structure 34 and function in an interconnected manner to produce complex molded components; it does not necessarily mean the inserts are connected to one another. Thus, the bottom tool structure 34 is configured to removably connect to all of the plurality of inserts 26, thereby creating the interconnected array 28. In such an embodiment, each of the inserts 26 can be located and positioned into the array 28 with protrusions or pins 36 associated with the upper tool face 38 of the bottom tool structure 34, together with pinholes or geometries associated with the base assembly 66 of each of the inserts 26.

In a preferred embodiment, the interconnected array 28 is connected to the bottom tool structure 34 for use in a compression molding operation. One exemplary compression molding operation is illustrated in FIG. 12 and configured for use with zone-based active tool heating and cooling via air.

Referring to FIG. 11, the compression molding operation 200 utilizing zone-based active tool heating and cooling includes a upper mold base 202 configured to heat and compress a ram 204. In an exemplary embodiment, the ram 204 compresses a charge comprised of polyether ether ketone (PEEK) having a 6:1 volume. Other materials and volumes of compressible materials are contemplated without deviating from the objects of the present disclosure, including but not limited to the polyaryletherketone (PAEK) family of semicrystalline thermoplastics, polyester fiberglass resins, fiber-reinforced thermoset composites, Torlon, Vespel, Poly(p-phenylene sulfide) (PPS), etc. The ram 204 is heated and compressed, forcing the melted charger into the array 28 comprising the plurality of inserts 26 of the present disclosure. The mold force on the outer boundaries 44 of the pieces 38 can generally be perpendicular to the ram 204 through the use of cooling differentials. The array 28, and more particularly the bottom tool structure 34, is operably connected to a lower mold base 206. With reference to FIG. 11, exhaust routes 208 are positioned on one or more sides of the mold cavity 210. The exhaust air proximate to the upper mold base 202 and the base 208 is routed through the exhaust routes 208 to control temperature on one or more sides of the mold cavity 210. Together with active forced air heating and cooling provided by the upper mold base 202 and/or the lower mold base 206, the compression molding operation 200 is improved in a variety of ways. Better temperature control over ram 204 is afforded during the compression process, which preserves the integrity of the material. This is particularly advantageous when using composites designed to meet demanding technical specifications.

The disclosure is not to be limited to the particular embodiments described herein. In particular, the disclosure contemplates numerous variations for the improved removable insert, system, and method capable of producing a molded component with an undercut. For example, the present disclosure envisions the removal of each of the pieces of an insert is automated by robotics. For another example, the inner boundary 44 of the pieces 38 need not be planar, but could be arcuate, tiered in a staircase configuration, and the like. In such an embodiment, the post member 70 would have a counterposing design and drafted for removal from the insert 26 to create the cavity 56. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the disclosure. It is understood that any other modifications, substitutions, and/or additions can be made, which are within the intended spirit and scope of the disclosure. For the foregoing, it can be seen that the disclosure accomplishes at least all that is intended.

The previous detailed description is of a small number of embodiments for implementing the disclosure and is not intended to be limiting in scope. The following claims set forth a number of the embodiments of the disclosure with greater particularity.

What is claimed is:

1. A system for producing a molded component, the system comprising:
an insert configured to be removable from the molded component and having a plurality of pieces configured to be positioned into an assembled configuration, wherein each of the plurality of pieces comprises:
(a) a plurality of contact surfaces each between at least two of the plurality of pieces in the assembled configuration;
(b) an outer boundary extending between the plurality of contact surfaces;
(c) an inner boundary extending between the plurality of contact surfaces and opposite the outer boundary;
(d) an upper boundary opposite a lower boundary, wherein the upper boundary and the lower boundary are separated by the outer boundary, the inner boundary, and the plurality of contact surfaces;
wherein the inner boundaries of the plurality of pieces collectively define a cavity within the insert in the assembled configuration; and
wherein the outer boundaries of the plurality of pieces collectively define a periphery of the insert in the assembled configuration; and
wherein the molded component is associated with the periphery of the insert.

2. The system of claim 1 wherein at least one of the plurality of pieces is removable from the molded component through the cavity.

3. The system of claim 1 further comprising:
a base member configured to be removably positionable adjacent the lower boundaries in the assembled configuration; and
a post member extending from the base member and configured to be removably positioned within the cavity in the assembled configuration.

4. The system of claim 1 further comprising:
an upper retention feature associated with the upper boundary of each of the plurality of pieces, wherein the upper retention features collectively define an upper retention member of the insert; and
a counterposing retention member configured to removably connect with the upper retention member to interlock the plurality of pieces in the assembled configuration.

5. The system of claim 4 wherein the upper retention member is a raised area extending outwardly from each of the upper boundaries; wherein the counterposing retention member is a retention cap having a recess in which the upper retention member is disposed in the assembled configuration.

6. The system of claim 3 further comprising:
a lower retention feature associated with the lower boundary of each of the plurality of pieces, wherein the lower retention features collectively define a lower retention member of the insert; and
a base retention feature associated with the base member and configured to removably connect with the lower retention member to interlock the plurality of pieces in the assembled configuration.

7. The system of claim 6 wherein the lower retention member is a raised boss extending outwardly from the lower boundaries; wherein the base retention member is a channel within the base member configured to create an interference fit with the raised boss in the assembled configuration.

8. The system of claim 1 wherein relative dimensions of the insert and the molded component prevent the insert from being wholly inserted or removed from the molded component in the assembled configuration.

9. The system of claim 1 wherein the inner boundary of at least one of the plurality of pieces is sized to be slidable into the cavity so as to be removable from the molded component through the cavity.

10. The system of claim 1 wherein the plurality of pieces are configured to be sequentially removed from the molded component.

11. The system of claim 3 wherein the base member and the post member are removed from the insert prior to sequential removal of the plurality of pieces from the molded component.

12. The system of claim 3 further comprising:
a bore extending through the post member;
a void within the counterposing retention member and aligned with the bore in the assembled configuration; and
a connecting member engaging the void and the bore to connect the post member and the counterposing retention member to interlock the plurality of pieces in the assembled configuration.

13. The system of claim 1 wherein the periphery of the insert is an arcuate structure.

14. The system of claim 4 wherein an upper surface of the counterposing retention member is dome-shaped to facilitate material flow and minimize material usage.

15. The system of claim 3 wherein the base member of the insert is secured to a bottom tool structure.

16. The system of claim 1 wherein the insert is one of a plurality of inserts arranged into an interconnected array; wherein the molded component includes a matrix of cells;
wherein each of the plurality of inserts is associated with one of the cells.

17. The system of claim 16 wherein the interconnected array of the plurality of inserts is interconnected by a bottom tool structure connected to all of the plurality of inserts.

18. The system of claim 15 wherein the bottom tool structure is operatively connected to a compression molding machine.

19. The system of claim 18 wherein the compression molding machine further comprises a ram and a base; wherein the ram and the base provide for active forced air heating and cooling of the molded component.

20. The system of claim 19 wherein the compression molding machine further comprises exhaust routes positioned on one or more sides of the mold; wherein exhaust air proximate the ram and the base is fed through the exhaust routes to control temperature on the one or more sides of the mold.

21. The system of claim 1 wherein the plurality of pieces is metallic.

22. A molding system comprising:
a mold;
an array of inserts configured to removably positioned within the mold, wherein each of the inserts comprises:
(a) a plurality of pieces configured to be assembled;
(b) a cavity within the insert at least partially bounded by the plurality of pieces;
wherein the mold and the array of inserts produce a molded component having a plurality of cells each associated with an undercut, wherein the undercuts of the molded component prevent removal of the inserts from the molded component; and
wherein at least one of the plurality of pieces associated with each of the inserts is collapsible into the cavity so as to be removable from the molded component.

23. The system of claim 22 wherein relative dimensions between the inserts and the undercuts require the plurality of pieces of each of the inserts be removed through one of the plurality of cells of the molded component in sequence.

24. The system of claim 22 wherein each of the inserts further comprises:
a post member extending through the cavity and connected to a base member; wherein the post member is removable from within each of the inserts.

25. The system of claim 24 wherein the plurality of pieces, the base member, and the post member are configured to interlock to comprise each of the inserts.

26. The system of claim 24 wherein the post member associated with one of the inserts is removed prior to removal of the plurality of pieces associated with the same one of the inserts.

27. The system of claim 24 further comprising:
a bottom tool member connecting all of the inserts in the array.

28. The system of claim 22 wherein the plurality of cells of the molded component are in a matrix.

29. The system of claim 22 wherein the plurality of pieces is assembled such that each of the plurality of pieces is adjacent to exactly two separate pieces of the plurality of pieces.

30. The system of claim 22 further comprising:
an upper retention member associated with an upper surface of each of the inserts and comprised of an upper retention feature associated with each of the plurality of pieces of one of the inserts; and
a counterposing retention member configured to removably connect with the upper retention member to interlock the plurality of pieces in the assembled configuration.

31. The system of claim 22 further comprising:
a lower retention member associated with a lower surface of each of the inserts and comprised of a lower retention feature associated with each of the plurality of pieces of one of the inserts; and
a base retention feature associated with the base member and configured to removably connect with the lower retention member to interlock the plurality of pieces in the assembled configuration.

32. The system of claim 30 where the counterposing retention member is substantially dome-shaped to facilitate material flow and minimize trim excess.

33. The system of claim 22 wherein each of the inserts is an arcuate structure.

34. The system of claim 22 wherein the molded component is an airflow diverter duct.

35. The system of claim 22 wherein the array of inserts is configured for a compression molding operation.

36. The system of claim 22 wherein the plurality of pieces comprises four pieces.

37. The system of claim 35 wherein the compression molding operation manages temperature of the mold via active forced air heating and cooling using multiple airstreams.

38. The system of claim 35 wherein the compression molding operation further comprises exhaust routes to control temperature on one or more sides of the mold.

39. A method for molding items comprising the steps of:
performing a molding operation to produce a molded component;
removing an insert having a plurality of pieces comprising the steps of:
(a) removing a post member extending through the insert thereby creating a cavity;
(b) moving a first piece of the plurality of pieces into the cavity of the insert, thereby making the first piece removable from the molded component;
(c) removing the first piece from the molded component, thereby creating an updated cavity;
(d) moving a second piece of the plurality of pieces into the updated cavity, thereby making the second piece removable from the molded component; and
(e) removing the second piece from the molded component.

40. The method of claim 39 wherein a portion of the updated cavity comprises the cavity.

41. The method of claim 39 further comprising the step of removing a retention cap configured to interlock the plurality of pieces.

42. The method of claim 41 further comprising the steps of:
providing a base member connected to the post member; and
disposing a lower retention feature associated with the insert within a base retention feature of the base member, wherein the lower retention feature is configured to interlock the plurality of pieces.

43. The method of claim 39 wherein the molded component has an undercut.

44. The method of claim 43 wherein undercut of the molded component prevents the insert from being removed from within the molded component except by moving the first piece into the cavity and the second piece into the updated cavity.

45. The method of claim 38 further comprising the steps of:
arranging the insert and additional inserts into an array; and
removably securing the array of the insert and the additional inserts to a bottom tool structure.

46. The method of claim 38 further comprising the step of trimming a crown portion of the molded component to expose a plurality of cells extending through the molded component.

47. The method of claim 45 further comprising the step of positioning the array on the bottom tool structure via pins associated with the bottom tool structure and the additional inserts and pinholes associated with the insert.

48. A device for producing a molded component having an undercut, the device comprising:
an insert comprised of a plurality of separate pieces individually removable from the molded component,
a cavity within the insert; and
wherein one of the plurality of separate pieces is collapsible into the cavity for subsequent removal from the molded component.

49. The device of claim 48 wherein remaining pieces of the plurality of separate pieces are iteratively or sequentially collapsible into the cavity for subsequent removal from the molded component.

50. The device of claim 49 wherein each of the plurality of pieces has a different geometry.

51. The device of claim 48 wherein the insert is of one of a plurality of inserts arranged in an array and connected to a bottom tool structure in a compression molding operation.
